(19) United States
(12) Patent Application Publication
(10) Pub. No.: US 2003/0089645 A1
(43) Pub. Date: May 15, 2003

(54) Screening device, in particular for material to be screened containing stones or concrete

(76) Inventor: Heinz Backers, Twist (DE)

Correspondence Address: TECHNOPROP COLTON, L.L.C., P O BOX 567685, ATLANTA, GA, 311567685

(21) Appl. No.: 10/282,789

(22) Filed: Oct. 29, 2002

(30) Foreign Application Priority Data
Nov. 15, 2001 (DE) 10156181.4

(51) Int. Cl. B07C 5/12

(52) U.S. Cl. 209/672

(57) ABSTRACT

The invention relates to a screening device, in particular for material to be screened containing stones or concrete, with a screening unit (10) having rotating screening elements (13), the screening elements (13) being arranged on a plurality of screening shafts (14) directed parallel to one another, and the screening elements (13) forming a screening plane (21). According to the invention, the screening shafts are divided into at least two groups, that is a first group (15) with screening shafts and a second group (16) with screening shafts, screening shafts of the first and second groups being arranged alternately. Furthermore, the screening shafts of one group (16) can be moved together and cross-axially in relation to the screening shafts of the other group (15).

### BACKGROUND OF THE INVENTION

1. Technical Field

The invention relates to a screening device, in particular for material to be screened containing stones or concrete, with a screening unit having rotating screening elements, the screening elements being arranged on a plurality of screening shafts directed parallel to one another, and the screening elements forming a screening plane.

2. Prior Art.

Problematical material to be screened, such as cohesive soil, possibly with stones, loam, clay, track ballast, in each case in particular with a grain size of less than 40-50 mm, can be screened well using a star-type screen. In this case, screening stars, preferably having rubber fingers, are provided as rotating screening elements on corresponding screening shafts. By virtue of the shape of the screening stars and the arrangement of the meshing, rotating screening shafts, the star-type screen has a good self-cleaning effect, see German Utility Model 89 06 721.5. However, even the star-type screen has to be cleaned from time to time. The screening of, in particular, cohesive soils with a grain size of less than 30 mm gradually leads to clogging of the star-type screen. The fingers of the screening stars are then slowed down by the material adhering to the screening shafts respectively arranged upstream and downstream. The frictional forces may even bring the screening unit to a standstill. The wearing of the screening elements and the required drive power increase greatly. Once the screening unit has come to a stop, it must be manually cleaned in its entirety.

### BRIEF SUMMARY OF THE INVENTION

An object of the present invention is to provide a screening device with a screening unit which can be cleaned easily and effectively. It is also intended for the function of the screening unit to be improved and an adjustment of the screening fraction to be made possible.

The screening device according to the invention is characterized by the following features:

a) the screening shafts are divided into at least two groups, that is a first group with screening shafts and a second group with screening shafts, screening shafts of the first and second groups being arranged alternately,

b) the screening shafts of one group can be moved together and cross-axially in relation to the screening shafts of the other group.

Essentially two different movement components are possible. In the case of a movement component in the conveying direction, a cleaning effect is automatically obtained on account of the meshing arrangement of the screening elements. The screening elements on the screening shafts of one group clean the intermediate spaces of the screening shafts of the other group. In addition to the cleaning effect, a fractioning effect occurs. Every second intermediate space between the screening shafts becomes wider. The material to be screened falling through can be coarser.

In the case of an adjustment of the screening shafts of one group with a component transverse to the conveying direction—for instance in the downward direction—the fractioning effect increases.

The invention is not restricted to screening devices with star-type screens. Disc-type screens may also be used in conjunction with the invention.

The screening shafts of one group are preferably movable obliquely downwards in relation to the screening plane, in particular in a direction between the conveying direction and a direction perpendicular to the conveying direction. The movement may be taken in a straight line or along a curved path, in particular in the form of part of a circle.

According to a further idea of the invention, the first group of screening shafts is held in a main frame and the second group of screening shafts is held in a secondary frame. The secondary frame is moved as required back and forth between at least two positions. The main frame remains in its position. Its screening elements continue to form the screening plane. The screening elements of the secondary frame define as it were a secondary screening plane, which lies beneath the screening plane.

An embodiment in which the screening shafts of one group are driven from one side of the screening unit and the screening shafts of the other group are driven from the other, opposite side of the screening unit is also advantageous. In the case of this arrangement, more space is available for the transmission elements required for the drive.

In an advantageous way, the screening unit is preceded by a bunker with a bunker conveyor and a transfer conveyor, the transfer conveyor, which takes over the material to be screened from the bunker conveyor, running considerably faster than the bunker conveyor. As a result, the material to be screened is evened out and transferred more uniformly to the screening unit. The transfer conveyor is preferably configured as a rising belt—a rising conveyor. The screening plane may also preferably be provided horizontally or rising slightly. The most favorable position depends on the material and the desired screening quality. In this constellation, the screening unit may be made relatively short, so that production is less costly, lower driving power is required and wear can occur only on few shafts.

Hydraulic motors, electric motors or even (relatively small) diesel engines are preferably provided as drives. The power transmission takes place in particular by means of one or more chain drives.

The screening device according to the invention may be stationary or mobile. Short configurations specifically are especially well suited for a mobile type of construction.

According to a further, independent idea of the invention, the screening unit is adjustable in its inclination, i.e. in the angle of a conveying direction of the screening plane with respect to a horizontal plane. The adjustment of the inclination in the downward direction permits basic cleaning by tipping off the material to be screened. Adjustment of the screening unit in the upward direction intensifies a shaking effect in the material to be screened. This improves the result of screening. Soiling does not occur as quickly. By contrast, a horizontal screening plane or screening plane set with a slight decline produces small vibrations in the material to be screened. The grain size also becomes somewhat finer. Consequently, the grain size or fractioning can be influenced by the angle of inclination of the screening plane.

In an advantageous way, the screening unit is pivotable about a tilting axis. This preferably runs parallel to the screening shafts, for instance in the region of the charging side, that is at the screen inlet. Other arrangements of the tilting axis, for instance near one end of the screen, or between the screen inlet and the end of the screen, in particular centrally, are also possible.

In an advantageous way, the tilting axis runs above the screening elements or screening shafts. A configuration with a tilting axis at about 10-30% of the length, calculated from the first screening shaft to the last screening shaft at the end of the screen, is particularly advantageous. For example, when there are a total of sixteen screening shafts, the tilting axis may be arranged just above the third screening shaft in the conveying direction.

According to a further embodiment of the invention, the screening unit can be tilted into a vertically downwardly directed position, in particular also beyond this. The material to be screened still lying on the screening unit can slide off over the end of the screen. This makes cleaning much easier after the screening unit has come to a standstill. Alternatively or additionally, pivoting of the screening unit into a vertically upwardly directed position may be envisaged. The end of the screen then points upwards. The material to be screened slides back onto conveying members preceding the screening unit.

The inclination adjustment of the screening unit in combination with appropriate positioning of a tilting axis may also lead to shortening of the overall length of the screen device as a whole (with the screening unit pivoted), for instance in the case of a preceding bunker with transfer conveyor.

Further features of the invention emerge from the patent claims and otherwise from the description. Features which are mentioned in connection with the screening shafts which are movable in relation to one another may also be relevant in conjunction with the screening unit which is adjustable in inclination.

### BRIEF DESCRIPTION OF THE DRAWINGS

Exemplary embodiments of the invention are explained in more detail below on the basis of drawings, in which:

FIG. 1 shows a screening unit with screening shafts on a main frame and secondary frame, in side view,

FIG. 2 shows the screening unit according to FIG. 1 with the secondary frame pivoted out,

FIG. 3 shows a mobile screening device with a tiltable screening unit, in side view,

FIG. 4 shows an enlarged representation of the screening unit according to FIG. 3, and

FIG. 5 shows another embodiment of the mobile screening device according to FIG. 3.

### DETAILED DESCRIPTION OF THE PREFERRED EMBODIMENTS

A screening unit 10 has a supporting framework 11 and a star-type screen 12. The basic construction of a star-type screen with screening elements meshing in one another, i.e. arranged in a plurality of rows and a staggered formation, is disclosed for example by German Utility Model 89 06 721.5. Individual screening elements 13 are formed in a star-shaped manner (not shown). Instead of this, rotating discs may also be provided. The present invention relates to star-type and disc-type screens.

The screening elements 13 are arranged on driven screening shafts 14. In this case, a subdivision into a first group 15 of screening shafts 14 and a second group 16 of screening shafts 14 is envisaged, see FIG. 2. The screening shafts of the first group 15 are held in a main frame 17, while the screening shafts of the second group 16 are arranged on a secondary frame 18.

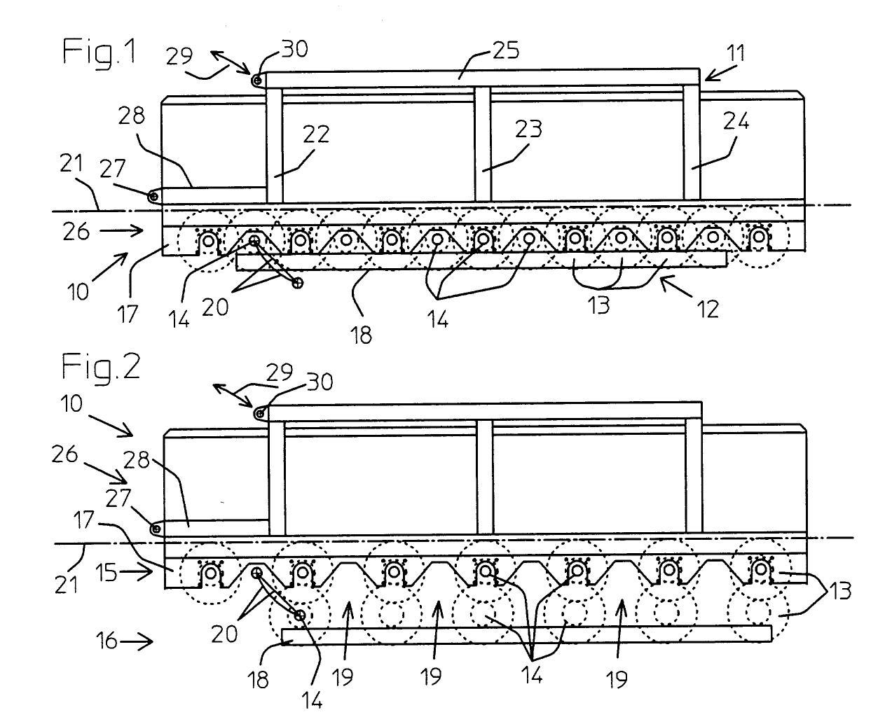

The secondary frame 18 runs parallel to the main frame 17 and is arranged movably in relation to the latter between a pivoted-in position according to FIG. 1 and a pivoted-out position according to FIG. 2.

The screening shafts 14 are distributed between the main frame 17 and the secondary frame 18 in such a way that, in the pivoted-in position according to FIG. 1, the screening shafts of the first group 15 alternate with those of the second group 16. Between two screening shafts of the first group 15 there is respectively arranged a screening shaft of the second group 16, and vice versa. In this case, the screening elements of a specific screening shaft always enter with circumferential regions between the screening elements of the neighboring screening shafts—known as a meshing arrangement.

In the pivoted-out position according to FIG. 2, the screening shafts of the secondary frame 18 have been respectively moved under the screening shafts of the main frame 17, so that clear gaps 19 have been formed between the screening shafts 14 or screening elements 13 of the main frame 17 on the one hand and at the same time also of the secondary shaft 18. In this state, cleaning of the screening unit 10 is easily possible. Instances of jamming caused by coarse material to be screened are highly improbable. Larger lumps can fall through the gaps 10.

The movement of the secondary frame 18 out of the pivoted-in position into the pivoted-out position takes place in a special way. A straight movement or a curved movement are preferred, for instance along part of a circle (about an axis corresponding to a screening shaft of the main frame). Both lines of movement are assigned the number 20 in FIGS. 1 and 2.

The direction of movement is preferably chosen such that the screening elements of the secondary frame 18 (second group 16) come somewhat closer to the screening shafts 14 of the main frame 17 (first group 15) on the path from the pivoted-in position into the pivoted-out position and thus bring about cleaning of the corresponding intermediate spaces. In the pivoted-out position according to FIG. 2, the secondary frame 18 extends parallel to and at a distance from the main frame 17. The screening elements 13 of the secondary frame 18 reach just up to the screening shafts 14 of the main frame 17.

The cleaning effect can be increased by certain properties of the individual screening elements. If they are screening elements (known per se) with flexible star fingers, the latter can be moved closer to the neighboring screening shafts than appears possible on the basis of the geometrical dimensions. The flexible star fingers yield and bend slightly on contact with the screening shafts. The adhering dirt is dislodged largely of its own accord. The individual star fingers also “beat” as it were against the neighboring screening shafts. The vibrations produced likewise enhance the cleaning. By specific choice of the path between the pivoted-in position and the pivoted-out position, the desired cleaning effect can be exactly planned.

It is also possible to make the individual screening elements able to yield by mounting them on the screening shafts in a resilient manner or with play.

In addition to the cleaning effect, a fractioning effect can occur by movement of every second screening shaft 14, in particular with a component in the conveying direction and parallel to the screening plane 21. By this type of movement of the screening shafts of the second group 16, some of the gaps for the material to be screened become narrower and some become wider. Larger lumps can fall down through the wider gaps.

The secondary frame 18 is held in a way not shown on pivoted levers or in linear guides. The movement is preferably performed by means of a hydraulic drive, likewise not shown.

In the pivoted-in position according to FIG. 1, all the screening elements 13 form a common screening plane 21. In the pivoted-out position according to FIG. 2, only the screening elements of the first group 15 are involved in the forming of the screening plane 21.

The main frame 17 forms an underside of the supporting framework 11. Provided on the upper side of the main frame 17 (as the supporting framework) are three upright struts 22, 23, 24, which are connected at their upper ends by a crossbar 25 extending in the conveying direction. Provided at a screen inlet 26 (charging side) of the screening unit 10 is a suspension 27, which forms a tilting axis for a pivoting movement of the screening unit 10. The tilting axis runs parallel to the screening shafts 14. The suspension 27 is arranged on a horizontal strut 28 just above the main frame 17. The horizontal strut 28 extends parallel to the conveying direction from the first upright strut 22 to the screen inlet 26.

The entire screening unit 10 can be pivoted about the tilting axis of the suspension 27. During operation, the screening unit 10 is aligned with the screening plane 21 such that it is preferably horizontal or rising slightly, in particular rising by up to about 30°. By changing the incline, certain screening conditions can be set, that is intensified vibrations by a greater incline and a somewhat finer grain size by a lesser incline. The last-mentioned effect specifically can be further enhanced by a slightly falling screening plane. The pivoting movement is indicated by a double-headed arrow 29. Provided on an end of the crossbar 25 on the charging side—near an upper end of the strut 22 is a suspension 30, which may serve as a point of engagement for a drawing member (not shown). Depending on the actuation of the drawing member, the desired inclination of the screening unit 10 is obtained.

The screening shafts 14 are driven individually or by means of a common chain drive in a way known per se. Details are therefore not shown. If a common drive is used, a division is expedient, that is one drive for the screening shafts of the first group 15 and a further drive for the screening shafts of the second group 16. For instance, a chain drive for the first group 15 may be provided on one side and a chain drive for the other group 16 may be provided on the other, opposite side of the screening unit 10.

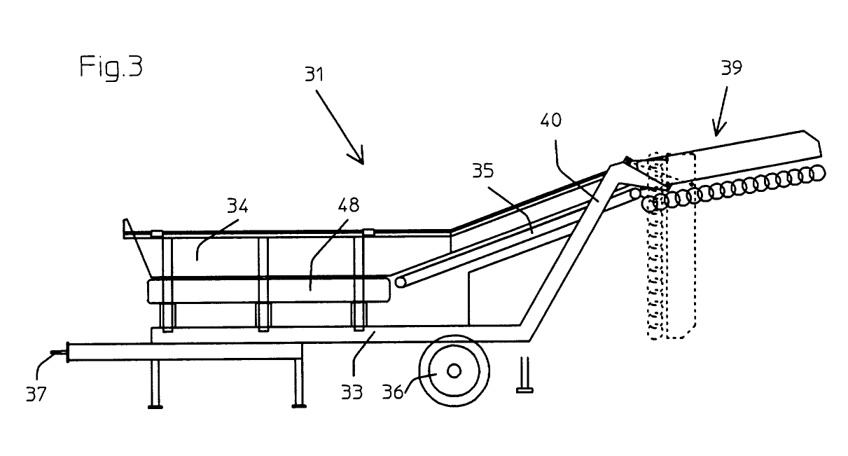

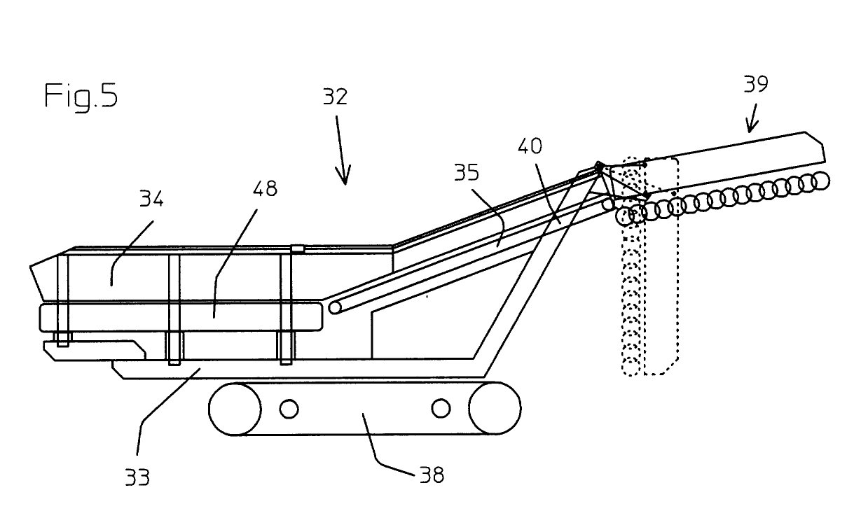

The screening unit 10 is part of a larger screening device, which in turn may be of a stationary or mobile configuration. FIGS. 3-5 show mobile screening devices 31, 32. Arranged on an undercarriage 33 are a bunker 34 and a rising belt 35 as a transfer conveyor. In the configuration according to FIG. 3, the undercarriage 33 is able to move about on wheels 36. Provided opposite from the rising belt 35 is a trailer coupling 37. By contrast, the screening device 32 in FIG. 5 is provided underneath the undercarriage 33 with a crawler-type traveling unit 38.

The rising belt 35 is adjoined at the top by a screening unit 39. The undercarriage 33 has at an end facing the rising belt 35 upwardly sloping supports 40. Arranged at each of their upper, free ends is a holding bracket 41 with a fork 42 at the end, in which a suspension 43 for the screening unit 39 is mounted. The suspension 43 is at the same time the location of a tilting axis for the screening unit 39.

The screening unit 39 is represented in a greatly simplified form. A screening casing 44, preferably open at the top, and meshing screening elements 45 arranged under it can be seen. The way in which they are formed, arranged and suspended is known per se or corresponds to the representation of FIGS. 1 and 2.

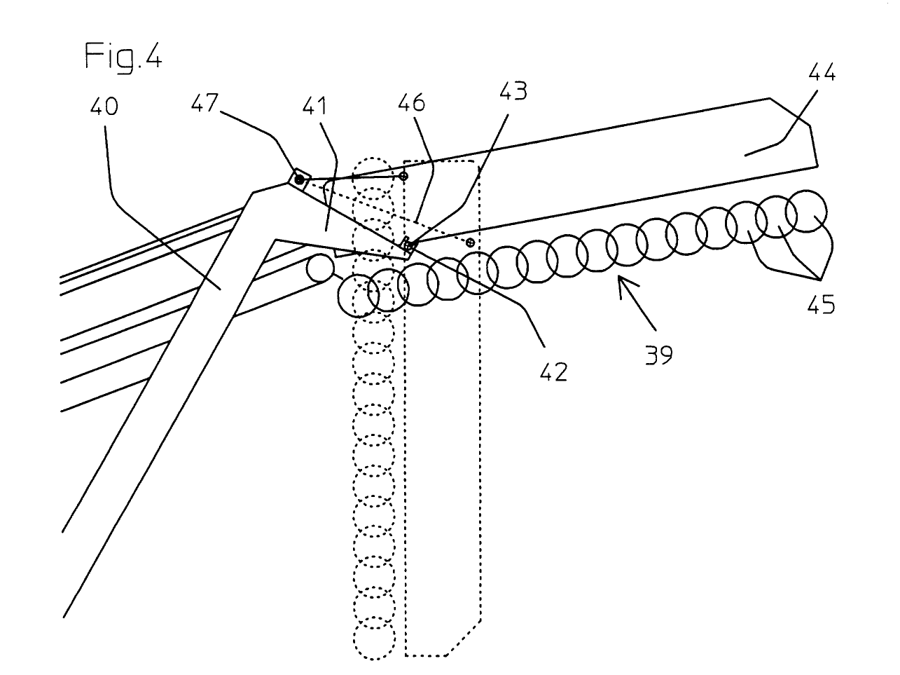

The screening unit 10 is pivotable about the suspension 43 between a slightly upwardly directed screening position, drawn in solid lines in FIG. 4, and a vertically downwardly directed cleaning or transporting position, drawn in dashed lines.

The suspension 43 is arranged just above a third screening shaft (in the case of a total of 16 screening shafts), with the enumeration of the screening shafts beginning at the charging side of the screening unit 39.

Provided for pivoting the screening unit 39 is a drawing member 46, which connects the screening casing 44 above the suspension 43 and at a distance from it to a bearing 47 in the region of a transition between the support 40 and the holding bracket 41, obliquely above the fork 42. In the screening position (solid representation in FIG. 4), the drawing member 46 is relatively short. For setting the cleaning position (dashed representation), the drawing member 46 must be moved out, drawn out, extended or the like.

The actual configuration of the drawing member 46 is not shown in any more detail. A simple drawing cable which is passed over the bearing 47 on a winch is conceivable. A hydraulic drawing bar may also be provided, or a drawing and pushing unit. This then makes a further movement possible, beyond the screening position shown in FIG. 4 into a sloping overhead position, for instance parallel to the support 40 or in secured abutment with the same.

There is a further special feature in connection with the rising belt 35. This adjoins an essentially horizontal bunker conveyor 48 and runs much faster than the bunker conveyor, that is about 30-200% faster. As a result, the material to be screened is evened out and passed more uniformly to the screening unit 39.

The screening devices or screening units according to the invention are especially well suited for the screening of track ballast with cohesive soil using screening stars.

### List of Reference Numerals

10 screening unit 32 screening device

11 supporting framework 33 undercarriage

12 star-type screen 34 bunker

13 screening elements 35 rising belt

14 screening shafts 36 wheels

15 first group 37 trailer coupling

16 second group 38 crawler-type traveling unit

17 main frame 39 screening unit

18 secondary frame 40 support

19 gaps 41 holding bracket

20 lines of movement 42 fork

21 screening plane 43 suspension

22 strut 44 screening casing

23 strut 44 screening elements

24 strut 46 drawing member

25 crossbar 47 bearing

26 screen inlet 48 bunker conveyor

27 suspension

28 horizontal strut

29 double-headed arrow

30 suspension

31 screening device

What is claimed is:

1. Screening device (31, 32), for material to be screened containing stones or concrete, with a screening unit (10, 39) having rotating screening elements (13, 45), the screening elements (13, 45) being arranged on a plurality of screening shafts (14) directed parallel to one another, and the screening elements (13, 45) forming a screening plane (21), characterized by the following features:
a) the screening shafts (14) are divided into at least two groups (15, 16), that is a first group (15) with screening shafts and a second group (16) with screening shafts, screening shafts of the first and second groups being arranged alternately, and
b) the screening shafts (14) of one group (16) can be moved together and cross-axially in relation to the screening shafts (14) of the other group (15).

2. Screening device according to claim 1, characterized in that the screening shafts (14) of one group (16) can be moved cross-axially and obliquely downwards.

3. Screening device according to claim 1, characterized in that the first group (15) of screening shafts (14) is held in a main frame (17) and the second group (16) of screening shafts (14) is held in a secondary frame (18).

4. Screening device according to claim 1, characterized in that the screening shafts (14) of one group (15) are driven from one side of the screening unit (10, 39) and the screening shafts (14) of the other group (16) are driven from the other, opposite side.

5. Screening device according to claim 1, characterized in that the screening unit (10, 39) is preceded by a bunker (34) with a bunker conveyor (48) and a transfer conveyor, the transfer conveyor, which takes over the material to be screened from the bunker conveyor (48), running faster than the bunker conveyor.

6. Screening device (31, 32), for material to be screened containing stones or concrete, with a screening unit (10, 39) having rotating screening elements (13, 45), the screening elements (13, 45) being arranged on a plurality of screening shafts (14) directed parallel to one another, and the screening elements (13, 45) forming a screening plane (21), characterized in that the screening unit (10, 39) is adjustable in its inclination, i.e. in the angle of a conveying direction of the screening plane (21) with respect to a horizontal plane.

7. Screening device according to claim 6, characterized in that the screening unit (10, 39) is pivotable about a tilting axis.

8. Screening device according to claim 7, characterized in that the tilting axis runs above the screening elements (13, 45) or screening shafts (14).

9. Screening device according to claim 7, characterized in that the screening unit (10, 39) can be tilted into a vertically downwardly directed position.

10. Screening device according to claim 2, characterized in that the first group (15) of screening shafts (14) is held in a main frame (17) and the second group (16) of screening shafts (14) is held in a secondary frame (18).

11. Screening device according to claim 10, characterized in that the screening shafts (14) of one group (15) are driven from one side of the screening unit (10, 39) and the screening shafts (14) of the other group (16) are driven from the other, opposite side.

12. Screening device according to claim 10, characterized in that the screening unit (10, 39) is preceded by a bunker (34) with a bunker conveyor (48) and a transfer conveyor, the transfer conveyor, which takes over the material to be screened from the bunker conveyor (48), running faster than the bunker conveyor.

13. Screening device according to claim 11, characterized in that the screening unit (10, 39) is preceded by a bunker (34) with a bunker conveyor (48) and a transfer conveyor, the transfer conveyor, which takes over the material to be screened from the bunker conveyor (48), running faster than the bunker conveyor.

14. Screening device according to claim 8, characterized in that the screening unit (10, 39) can be tilted into a vertically downwardly directed position.
